(19) United States
(12) Patent Application Publication
(10) Pub. No.: US 2025/0384372 A1
(43) Pub. Date: Dec. 18, 2025

(54) OPERATION WORKFLOW GENERATION METHOD AND RELATED PRODUCTS

(71) Applicants: Guangzhou Xiyin International Import and Export Co., Ltd., Guangdong (CN); Shenzhen Xiyin Information Technology Co., Ltd., Guangdong (CN); Nanjing Xiyin Ecommerce Co., Ltd., Jiangsu (CN)

(72) Inventors: QING YANG, Jiangsu (CN); MING XU, Jiangsu (CN); XIN LIANG, Jiangsu (CN); XINGGUO MA, Jiangsu (CN)

(21) Appl. No.: 18/901,502

(22) Filed: Sep. 30, 2024

(30) Foreign Application Priority Data
Jun. 18, 2024 (CN) 202410788730.6

(51) Int. Cl. G06Q 10/0631

(52) U.S. Cl. CPC G06Q 10/06316

(57) ABSTRACT

A method for generating an operation workflow includes acquiring a workflow configuration content, constructing each workflow module based on each node configuration content in the workflow configuration content, combining each workflow module, based on a workflow description in the workflow configuration content, to obtain an execution workflow framework, and loading an operation code for each workflow module in the execution workflow framework, based on the execution workflow framework and the operation content, to obtain operation functional services, and performing functional services combination, based on operation requirements and the at least one operation functional services, to obtain an operation workflow, and saving the operation workflow that has passed the verification to obtain the target execution workflow. This application can quickly generate operation functional services and efficiently organize and arrange operation functional services, reducing the complexity of workflow construction and improving the user experience.

### CROSS REFERENCE TO RELATED APPLICATIONS AND CLAIM OF PRIORITY

This application claims the benefit under 35 USC § 119 of Chinese Patent Application No. 202410788730.6 filed on Jun. 18, 2024, in the Chinese Intellectual Property Office, the entire disclosure of which is incorporated herein by reference for all purposes.

### BACKGROUND

### 1. Technical Field

The present application generally relates to the field of computer technology. More specifically, the present application relates to an operation workflow generation method and related products.

### 2. Background Art

With the increasing popularity of Internet technology and the digital transformation of traditional industries, each enterprise needs to carry out IT transformation for its own operation functions. Among them, in the scenario of individual customers, it is necessary to provide fast and stable IT services to improve user experience. At the same time, in the continuous iteration of the operation, the IT system needs to be upgraded frequently. The traditional upgrade process is to upgrade the operation code written by full-time developers, but the problem with this approach is that even small functional adjustments require a complete process of requirement review, development, testing, and acceptance, and the overall efficiency is low. However, in the context of microservices and cloud native, simple functional services within the system can exist independently. Therefore, specific operation functions can be provided by efficiently organizing these functional services to provide users with fast and stable services.

In view of this, there is an urgent need to provide an operation workflow generation method so that operation functional services can be quickly generated and efficiently organized and orchestrated, reducing the complexity of workflow construction and improving user experience.

### SUMMARY

In order to at least solve one or more of the technical problems mentioned above, the present application proposes an operation workflow generation method and related products in multiple aspects.

In the first aspect, the present application provides an operation workflow generation method, comprising: acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end.

In some embodiments, constructing each workflow module based on each node configuration content in the workflow configuration content comprises: performing a legality check on the workflow configuration content to determine that the workflow structure corresponding to the workflow configuration content is a directed acyclic graph; and constructing each workflow module according to each node configuration content in the workflow structure, and performing a legality check on each workflow module.

In the second aspect, the present application provides an operation workflow generation method, comprising: receiving an execution workflow framework sent by a platform development end; loading an operation code for each workflow module in the execution workflow framework, based on the execution workflow framework and the operation content, to obtain operation functional services; and sending the operation functional service to an operation manipulating end.

In some embodiments, loading an operation code for each workflow module in the execution workflow framework, based on the execution workflow framework and the operation content may comprise: loading the operation code for each workflow module in the execution workflow framework based on the execution workflow framework and the operation content through a preset design pattern.

In some embodiments, the operation workflow generation method further comprises: semantically mapping the framework name of each workflow module with the name of each operation module in the operation content.

In the third aspect, the present application provides an operation workflow generation method, comprising: receiving at least one operation functional services sent by an operation development end; performing functional services combination based on operation requirements and the at least one operation functional services, to obtain an operation workflow; and saving the operation workflow that has passed the verification to obtain the target execution workflow.

In some embodiments, after saving the operation workflow that has passed the verification, the method further comprises: assigning a workflow number to the target execution workflow.

In some embodiments, performing functional services combination based on operation requirements and the at least one operation functional services comprises: selecting a required operation functional service, based on the operation requirements, from at least one operation functional services through a visualization view tool, to perform functional service combination.

In some embodiments, after performing functional services combination based on operation requirements and the at least one operation functional services, to obtain an operation workflow, the method further comprises: verifying the operation workflow.

In the fourth aspect, the present application provides a method for generating an operation workflow, comprising: acquiring a workflow configuration content; constructing each workflow module based on each node configuration content in the workflow configuration content; combining each workflow module, based on a workflow description in the workflow configuration content, to obtain an execution workflow framework; loading an operation code for each workflow module in the execution workflow framework, based on the execution workflow framework and the operation content, to obtain operation functional services; performing functional services combination, based on operation requirements and the at least one operation functional services, to obtain an operation workflow; and saving the operation workflow that has passed the verification to obtain the target execution workflow.

In some embodiments, constructing each workflow module based on each node configuration content in the workflow configuration content comprises: performing a legality check on the workflow configuration content to determine that the workflow structure corresponding to the workflow configuration content is a directed acyclic graph; and constructing each workflow module according to each node configuration content in the workflow structure, and performing a legality check on each workflow module.

In some embodiments, loading an operation code for each workflow module in the execution workflow framework, based on the execution workflow framework and the operation content comprises: loading the operation code for each workflow module in the execution workflow framework based on the execution workflow framework and the operation content through a preset design pattern.

In some embodiments, the operation workflow generation method further comprises: semantically mapping the framework name of each workflow module with the name of each operation module in the operation content.

In some embodiments, after saving the operation workflow that has passed the verification, the method further comprises: assigning a workflow number to the target execution workflow.

In some embodiments, performing functional services combination based on operation requirements and the at least one operation functional services comprises: selecting a required operation functional service, based on the operation requirements, from at least one operation functional services through a visualization view tool, to perform functional service combination.

In some embodiments, after performing functional services combination based on operation requirements and the at least one operation functional services, to obtain an operation workflow, the method further comprises: verifying the operation workflow.

In the fifth aspect, the present application provides a device for generating an operation workflow, comprises: memory; and at least one processor configured for: acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end; or
receiving an execution workflow framework sent by a platform development end; loading an operation code for each workflow module in the execution workflow framework, based on the execution workflow framework and the operation content, to obtain operation functional services; and sending the operation functional service to an operation manipulating end; or
receiving at least one operation functional services sent by an operation development end; performing functional services combination based on operation requirements and the at least one operation functional services, to obtain an operation workflow; and saving the operation workflow that has passed the verification to obtain the target execution workflow; or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.

In the sixth aspect, the present application provides a non-transitory machine-readable medium having stored thereon a program code for operation workflow generation, wherein when the program code is executed by at least one processor, the code guides the execution operation of the at least one processor, comprising:
acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end; or
receiving an execution workflow framework sent by a platform development end; loading an operation code for each workflow module in the execution workflow framework, based on the execution workflow framework and the operation content, to obtain operation functional services; and sending the operation functional service to an operation manipulating end; or
receiving at least one operation functional services sent by an operation development end; performing functional services combination based on operation requirements and the at least one operation functional services, to obtain an operation workflow; and saving the operation workflow that has passed the verification to obtain the target execution workflow; or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.

The technical solution provided by this application may have the following beneficial effects:

The operation workflow generation method and related products provided by the present application may acquire a workflow configuration content through the platform development end; construct each workflow module based on each node configuration content in the workflow configuration content; and combine each workflow module, based on a workflow description in the workflow configuration content, to obtain an execution workflow framework, and then send the execution workflow framework to the operation development end, so as to provide a general orchestration engine framework for the operation development end. Further, the operation development end may load an operation code for each workflow module in the execution workflow framework, based on the execution workflow framework and the operation content, to obtain operation functional services, realizes the writing of functional code within the operation, abstracts the complexity of the domain, and reduces the cognitive cost. Further, the operation manipulating end may receive at least one operation functional services sent by an operation development end; perform functional services combination based on operation requirements and the at least one operation functional services to obtain the operation workflow; and then save the operation workflow that has passed the verification to obtain the target execution workflow. So that the operation manipulating end can perform operation orchestration based on the relevant content of their own operation domain to generate a target execution workflow, and thus the complexity of configuration is greatly reduced.

In general, this application can quickly generate operation functional services and efficiently organize and arrange operation functional services, reduce the complexity of workflow construction, and improve the user experience.

### BRIEF DESCRIPTION OF THE DRAWINGS

By reading the drawings and the detailed description below, the above and other purposes, features and advantages of the exemplary embodiments of the present application will become easy to understand. In the drawings, several embodiments of the present application are shown in an exemplary and non-limiting manner, and the same or corresponding reference numerals represent the same or corresponding parts, wherein:

FIG. 1 is an exemplary flow chart of a method for generating an operation workflow according to some embodiments of the present application;

FIG. 2 is an exemplary flow chart of a method for generating an operation workflow according to some other embodiments of the present application;

FIG. 3 is an exemplary flow chart of a method for generating an operation workflow according to some other embodiments of the present application;

FIG. 4 is an exemplary flow chart of a method for generating an operation workflow according to yet other embodiments of the present application;

FIG. 5 is a schematic diagram of the structure of a device for generating an operation workflow according to an embodiment of the present application.

### DETAILED DESCRIPTION

The following will be in conjunction with the drawings in the embodiments of the present application to clearly and completely describe the technical solutions in the embodiments of the present application. Obviously, the described embodiments are a part of the embodiments of the present application, rather than all the embodiments. For the simplicity and clarity of the description, the reference numerals of drawings may be repeated in the drawings to indicate corresponding or similar elements when deemed appropriate. In addition, the present application sets forth many specific details in order to provide a thorough understanding of the embodiments described herein. However, it will be understood by the person of ordinary skill in the art that the embodiments described herein may be practiced without these specific details. In other cases, well-known methods, processes and components are not described in detail to avoid blurring the embodiments described herein. Moreover, the description should not be regarded as limiting the scope of the embodiments described herein. Based on the embodiments in the present application, all other embodiments obtained by the person of ordinary skill in the art without making creative work are within the scope of protection of the present application.

It should be understood that the possible terms “first” or “second” etc. in the claims, the specification and drawings disclosed in this application are used to distinguish different objects, rather than to describe a specific order. The terms “include” and “comprise” used in the specification and the claims of this application indicate the presence of the described features, wholes, steps, operations, elements and/or components, but do not exclude the presence or addition of one or more other features, wholes, steps, operations, elements, components and/or their collections.

It should also be understood that the terms used in the specification of this application are only for the purpose of describing specific embodiments and are not intended to limit the present application. As used in the specification and the claims of this application, unless the context clearly indicates otherwise, the singular forms of “a”, “an” and “the” are intended to include plural forms. It should also be further understood that the term “and/or” used in the specification and the claims of this application refers to any combination of one or more of the associated listed items and all possible combinations, and includes these combinations.

As used in the specification and claims of this application, the term “if” may be interpreted as “when” or “once” or “in response to a determination” or “in response to a case where something is detected” depending on the context. Similarly, the phrases “if it is determined” or “if a [described condition or event] is detected” may be interpreted as “once determining” or “in response to determining” or “once detecting [the described condition or event]” or “in response to detecting [the described condition or event]” depending on the context.

In the continuous iteration of an operation, IT systems need to be upgraded frequently. The traditional upgrade process is to upgrade operation code written by full-time developers, but the problem with this approach is that even small functional adjustments require a complete process of requirement review, development, testing, and acceptance, and the overall efficiency is low. However, in the context of microservices and cloud native, simple functional services within the system can exist independently. Therefore, these functional services can be efficiently organized to provide specific operation functions to provide users with fast and stable services.

In view of this, there is an urgent need to provide an operation workflow generation method so that operation functional services can be quickly generated and efficiently organized and orchestrated, reducing the complexity of workflow construction and improving user experience.

The specific implementation of the present application is described in detail below in conjunction with the drawings.

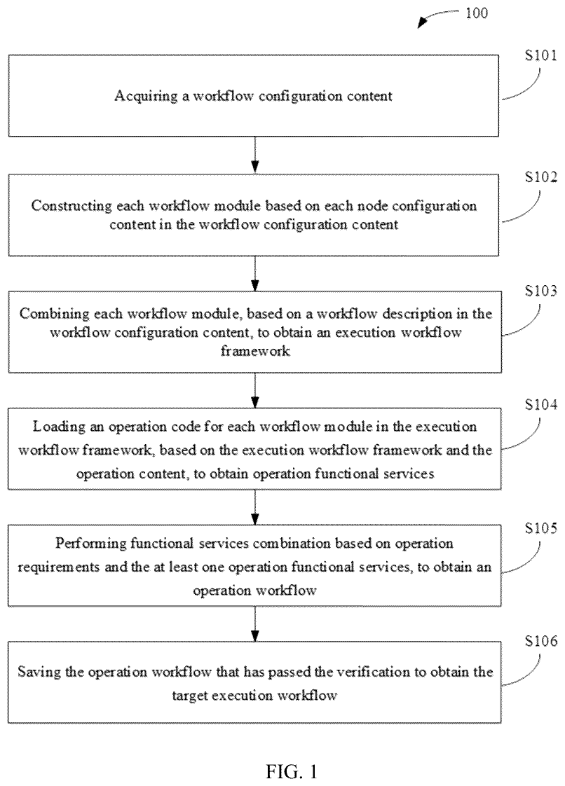

FIG. 1 shows an exemplary flow chart of a method for generating an operation workflow in some embodiments of the present application. Referring to FIG. 1, the method for generating an operation workflow shown in the embodiment of the present application may include:

In Step S101, acquiring a workflow configuration content. In the implementation of this application, the aforementioned workflow configuration content refers to the configuration that may be used to generate an executable workflow, which is generally used to describe the execution content of the workflow, and may be described in, for instance, xml, json or other domain-specific languages.

In Step S102, constructing each workflow module based on each node configuration content in the workflow configuration content. In the embodiment of the present application, the process of the operation functional service may be performed with module abstraction, based on the workflow configuration content, to form a directed acyclic graph (DAG) to express the process of the operation functional service, so that each workflow module is correspondingly constructed based on each node configuration content in the directed acyclic graph.

In Step S103, combining each workflow module, based on a workflow description in the workflow configuration content, to obtain an execution workflow framework. In the embodiment of the present application, the aforementioned workflow description expresses the sequential relationship between the workflow modules, so that each workflow module is combined based on a workflow description to obtain an execution workflow framework in the correct sequence.

In Step S104, loading an operation code for each workflow module in the execution workflow framework, based on the execution workflow framework and the operation content, to obtain operation functional service. In the embodiment of the present application, the aforementioned loading an operation code refers to writing the operation code for each workflow module obtained by the aforementioned module abstraction according to the operation content that needs to be implemented, and when the writing code is completed, the executable program may be released, which is the aforementioned operation functional service.

In Step S105, performing functional services combination based on operation requirements and the at least one operation functional services, to obtain an operation workflow.

In an embodiment of the present application, the actual operator may perform functional services combination, based on operation requirements, for the at least one operation functional services, to obtain an operation workflow that meets the operation requirements. In some exemplary application scenarios, the actual operator may perform functional services combination by dragging and dropping the operation functional services. It can be understood that there are various ways to perform functional services combination for at least one operation functional service. In actual applications, it is necessary to select an appropriate way to perform functional services combination according to the actual application situation. The present application does not impose any restrictions in this regard.

In Step S106, saving the operation workflow that has passed the verification to obtain the target execution workflow. The operation workflow obtained after combining is verified to check whether there are conflicts or errors in the operation workflow, and the verified operation workflow is saved, then the saved target execution workflow may be prepared for execution.

This application acquires a workflow configuration content through the platform development end, constructs each workflow module based on each node configuration content in the workflow configuration content, and combines each workflow module based on a workflow description in the workflow configuration content to obtain an execution workflow framework, and then sends the execution workflow framework to the operation development end, so as to provide a general orchestration engine framework for the operation development end. Further, the operation development end loads an operation code for each workflow module in the execution workflow framework, based on the execution workflow framework and the operation content, to obtain operation functional services, which realizes the writing of functional code within the operation, abstracts the complexity of the domain, and reduces the cognitive cost. Further, the operation manipulating end may receive at least one operation functional services sent by an operation development end, perform functional services combination based on operation requirements and the at least one operation functional services, to obtain an operation workflow, and then save the operation workflow that has passed the verification to obtain the target execution workflow, so that the operation manipulating end can perform operation orchestration based on the relevant content of their own operation field to form a target execution workflow, and thus the complexity of configuration is greatly reduced.

In general, this application can quickly generate operation functional services through the division of labor among the platform development end, the operation development end, and the operation manipulating end, and can efficiently organize and orchestrate operation functional services, reduce the complexity of workflow construction, and improve the user experience.

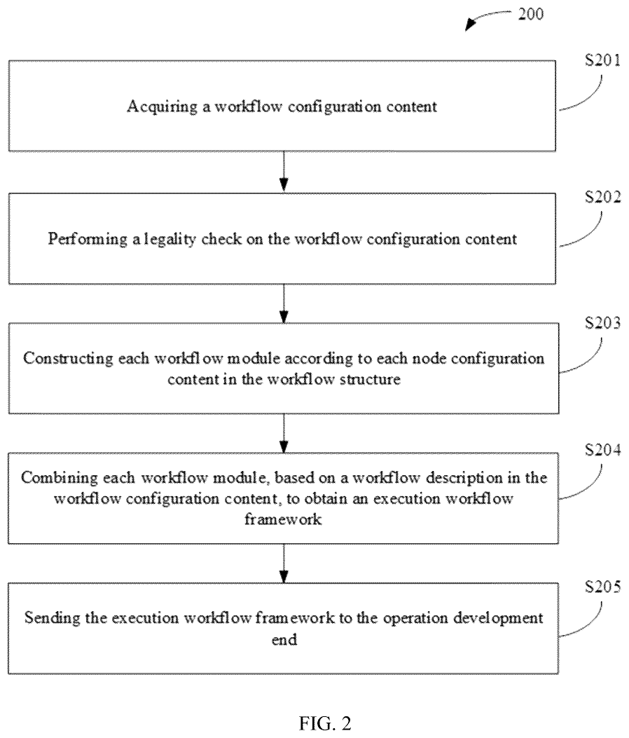

In some embodiments, the platform development end may be responsible for delivering the execution workflow framework to the operation development end in order to construct a directed acyclic graph. The construction process of the execution workflow framework will be described in detail below in conjunction with FIG. 2, which shows an exemplary flow chart of an operation workflow generation method of some other embodiments of the present application. Please refer to FIG. 2. The operation workflow generation method shown in the embodiment of the present application may include:

In Step S201, acquiring a workflow configuration content. In the embodiment of the present application, the content of Step S201 is substantially the same as that of Step S101, and will not be described in detail here.

In Step S202, performing a legality check on the workflow configuration content. In the embodiment of the present application, the workflow configuration content is performed a legality check to determine whether the workflow structure corresponding to the workflow configuration content is a directed acyclic graph. If so, the workflow configuration content can pass the legality check.

In Step S203, constructing each workflow module according to each node configuration content in the workflow structure. In the embodiment of the present application, while being constructed, each workflow module may be performed a legality check to prevent conflicts or errors.

In Step S204, combining each workflow module, based on a workflow description in the workflow configuration content, to obtain an execution workflow framework. In the embodiment of the present application, the aforementioned workflow description expresses the sequential relationship among the workflow modules, so that each workflow module is combined based on a workflow description to obtain an execution workflow framework in the correct sequence.

In Step S205, sending the execution workflow framework to the operation development end. The above Step S201 to Step S204 may be executed in memory, so since there are constraints (DAG form) on the workflow and it is loaded in memory in advance, therefore, low latency (millisecond level) and high throughput (high concurrency) can be achieved. After the execution workflow framework is built, it is sent to the operation development end for the next step of code writing.

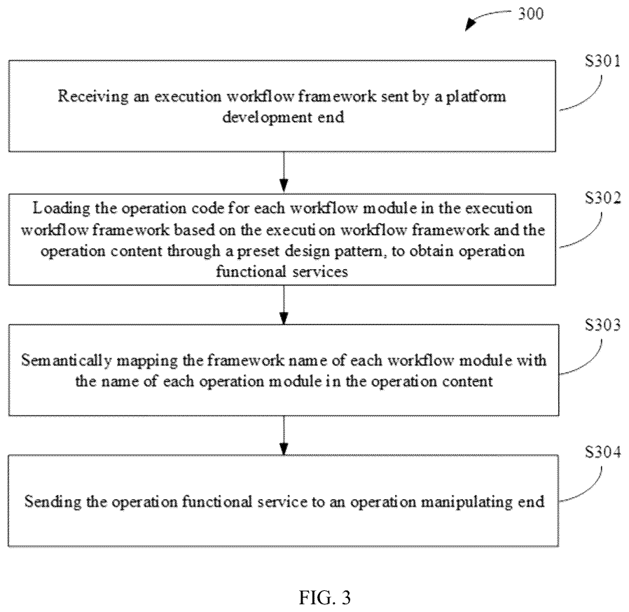

In some embodiments, the operation development end may be responsible for writing code based on the execution workflow framework to generate operation functional services. The following will describe in detail the generation process of operation functional services in conjunction with FIG. 3, which shows an exemplary flow chart of an operation workflow generation method in some other embodiments of the present application. Please refer to FIG. 3. The operation workflow generation method shown in the embodiment of the present application may include:

In Step S301, receiving an execution workflow framework sent by a platform development end.

In Step S302, loading the operation code for each workflow module in the execution workflow framework based on the execution workflow framework and the operation content through the preset design pattern, to obtain operation functional services. In the embodiment of the present application, the aforementioned preset design pattern refers to the software design pattern, which may include but is not limited to the Factory Pattern and the Proxy Pattern. Among them, the use of the Factory Pattern can make each workflow module in the execution workflow framework better reused, and the use of the Proxy Pattern can make the operation code better fault-tolerant. Loading the operation code through a preset design pattern can make the coding work easier and more maintainable.

In Step S303, semantically mapping the framework name of each workflow module with the name of each operation module in the operation content. The semantic mapping is based on a convention. For example, assuming that the current operation module is a module for preprocessing, in order to facilitate the operation manipulating end to understand and use, this module may be simply named “preprocess module”, and when writing code for this module in the operation development end, the used name may be “PreprocessModule”. Therefore, it is necessary to map the “preprocess module” to “PreprocessModule” to facilitate the operation manipulating end to call and execute the corresponding code process.

In Step S304, sending the operation functional service to an operation manipulating end. In the embodiment of the present application, after the operation development end completes the code writing, the formed operation functional service may be delivered to the operation manipulating end, and the operation functional service may include a UI to facilitate the operation manipulating end to combine and use the operation functional service.

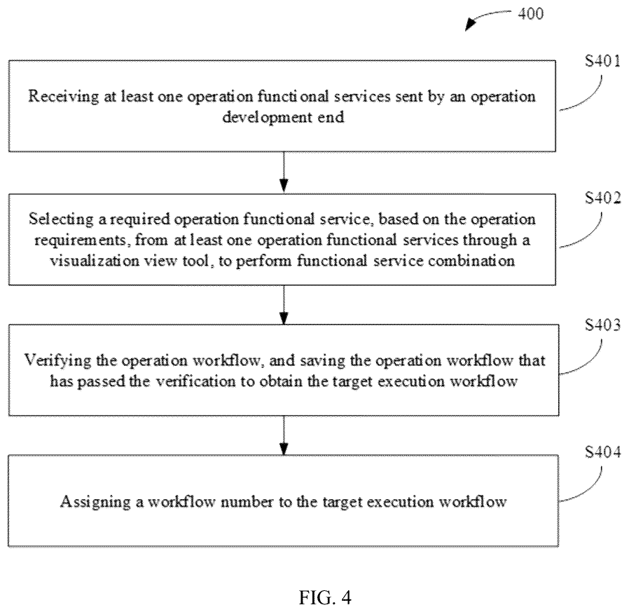

In some embodiments, the operation manipulating end may use the visualization view tool to operate and combine the operation functional services to form a target execution workflow. The formation process of the target execution workflow will be described in detail below in conjunction with FIG. 4, which shows an exemplary flow chart of an operation workflow generation method in some other embodiments of the present application. Please refer to FIG. 4. The operation workflow generation method shown in the embodiment of the present application may include:

In Step S401, receiving at least one operation functional services sent by an operation development end.

In Step S402, selecting a required operation functional service, based on the operation requirements, from at least one operation functional services through a visualization view tool, to perform functional service combination. In an embodiment of the present application, the visualization view tool may be a web-based terminal. In actual applications, a suitable visualization view tool may be selected according to actual application conditions, and the present application does not impose any restrictions in this regard.

Exemplarily, the operation requirement of product recommendation of e-commerce is used as an example to illustrate. Generally speaking, it usually takes several operation steps for users to see a product recommendation list. Among them, Step One is product recall, that is, picking out the products that the user may be interested in according to the user's situation; Step Two is product ranking, that is, putting the products that the user is most interested in at the front according to the user's interest; Step Three is product rearrangement, that is, further adjusting the list according to actual operation characteristics, such as putting a small number of medium-priced products in a more forward position. When faced with the above operation requirements, the operation manipulating end may drag and drop the three operation functional services of product recall, product ranking and product rearrangement in sequence on the web-based terminal to perform operation combination to form an operation workflow that meets the above operation requirements.

In Step S403, verifying the operation workflow, and saving the operation workflow that has passed the verification to obtain the target execution workflow. In the embodiment of the present application, the operation workflow that formed after performing combination may be verified to check whether there are conflicts or errors in the operation workflow, and the operation workflow that passes the verification will be saved as the target execution workflow.

In Step S404, a workflow number is assigned to the target execution workflow. Taking the above exemplary operation requirements as an example for technical description, after the workflow number is assigned to the target execution workflow corresponding to the exemplary operation requirements, when the user needs to obtain relevant data for product recommendation, the workflow number can be specified to trigger the execution of the corresponding workflow code, which can be triggered based on, for instance, an HTTP request or other methods.

Corresponding to the embodiment of the aforementioned application function realization method, the present application also provides a device and the corresponding embodiment for executing the operation workflow generation method.

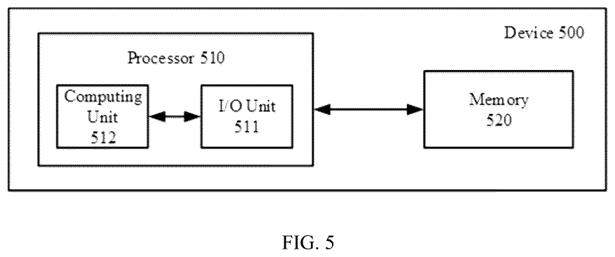

FIG. 5 shows a schematic diagram of the hardware configuration of a device 500 for generating an operation workflow that can implement the operation workflow generation method of an embodiment of the present application. As shown in FIG. 5, the device 500 for generating an operation workflow may include a processor 510 and a memory 520. In the device 500 for generating an operation workflow in FIG. 5, only the components related to the present embodiment are shown. Therefore, it is obvious to the person of ordinary skill in the art that the device 500 for generating an operation workflow may also include common components that are different from the components shown in FIG. 5. For example: a fixed-point operator.

The device 500 for generating an operation workflow may correspond to a computing device having various processing functions, such as functions for generating a neural network, training or learning a neural network, quantizing a floating-point neural network to a fixed-point neural network, or retraining a neural network. For example, the device 500 for generating an operation workflow may be implemented as various types of devices, such as a personal computer (PC), a server device, a mobile device, etc.

The processor 510 controls all functions of the device 500 for generating an operation workflow. For example, the processor 510 controls all functions of the device 500 for generating an operation workflow by executing a program stored in the memory 520 on the device 500 for generating an operation workflow. The processor 510 may be implemented by a central processing unit (CPU), a graphics processing unit (GPU), an application processor (AP), an intelligence processor chip (IPU), etc. provided in the device 500 for generating an operation workflow. However, the present application is not limited thereto.

In some embodiments, the processor 510 may include an input/output (I/O) unit 511 and a computing unit 512. The I/O unit 511 may be used to acquire various data, such as the workflow configuration content. Exemplarily, the computing unit 512 may be used to construct each workflow module based on each node configuration content in the workflow configuration content acquired via the I/O unit 511; combine each workflow module based on a workflow description in the workflow configuration content to obtain an execution workflow framework; load an operation code for each workflow module in the execution workflow framework, based on the execution workflow framework and the operation content, to obtain operation functional services; perform functional services combination based on operation requirements and the at least one operation functional services, to obtain an operation workflow; and save the operation workflow that has passed the verification to obtain a target execution workflow. This target execution workflow, for example, may be output by the I/O unit 511. The output data may be provided to the memory 520 for other devices to read and use (not shown in figures), or may be directly provided to other devices for using.

The memory 520 is hardware for storing various data processed in the device 500 for generating an operation workflow. For example, the memory 520 may store the processed data and the data to be processed in the device 500 for generating an operation workflow. The memory 520 may store data sets involved in the process of the operation workflow generation method that has been processed or will be processed by the processor 510, such as the workflow configuration content, etc. In addition, the memory 520 may store applications, drivers, etc. that are used to drive the device 500 for generating an operation workflow. For example, the memory 520 may store various programs related to the operation workflow generation method that will be executed by the processor 510. The memory 520 may be a DRAM, but the present application is not limited thereto. The memory 520 may include at least one kind of a volatile memory or a non-volatile memory. The non-volatile memory may include a read-only memory (ROM), a programmable ROM (PROM), an electrically programmable ROM (EPROM), an electrically erasable programmable ROM (EEPROM), a flash memory, a phase-change RAM (PRAM), a magnetic RAM (MRAM), a resistive RAM (RRAM), a ferroelectric RAM (FRAM), etc. The volatile memory may include a dynamic RAM (DRAM), a static RAM (SRAM), a synchronous DRAM (SDRAM), a PRAM, an MRAM, an RRAM, a ferroelectric RAM (FeRAM), etc. In an embodiment, the memory 520 may include at least one of a hard disk drive (HDD), a solid state drive (SSD), a compact flash memory (CF), a secure digital (SD) card, a micro secure digital (Micro-SD) card, a mini secure digital (Mini-SD) card, an extreme digital (xD) card, caches, or a memory stick.

In summary, the specific functions implemented by the memory 520 and the processor 510 of the device 500 for generating an operation workflow provided in the Detailed Description of the specification may be explained in comparison with the aforementioned Detailed Description in the specification, and can achieve the technical effects of the aforementioned Detailed Description. It's not detailly described here.

In this embodiment, the processor 510 may be implemented in any suitable manner. For example, the processor 510 may take the form of a microprocessor or a processor, and a computer-readable medium, a logic gate, a switch, an application specific integrated circuit (ASIC), a programmable logic controller, an embedded microcontroller, etc., which stores the computer-readable program code (e.g., software or firmware) executable by this (micro) processor.

It should also be understood that any module, unit, component, server, computer, terminal or device that executes instructions in the examples herein may include or have access in other ways to the computer-readable medium, such as storage medium, computer storage medium or data storage devices (the removable and/or the non-removable), such as disks, optical disks or tapes. Computer storage medium may include volatile and non-volatile, removable and non-removable medium implemented in any method or technology for storing information, such as computer-readable instructions, data structures, program modules or other data.

The foregoing content can be better understood in accordance with the following terms:

Clause A1. A method for generating an operation workflow, including: acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end.

Clause A2. A method according to Clause A1, wherein said constructing each workflow module based on each node configuration content in the workflow configuration content includes: performing a legality check on the workflow configuration content to determine that the workflow structure corresponding to the workflow configuration content is a directed acyclic graph; and constructing each workflow module according to each node configuration content in the workflow structure, and performing a legality check on each workflow module.

Clause A3. A method for generating an operation workflow, including: receiving an execution workflow framework sent by a platform development end; loading an operation code for each workflow module in the execution workflow framework, based on the execution workflow framework and the operation content, to obtain operation functional services; and sending the operation functional service to an operation manipulating end.

Clause A4. A method according to Clause A3, wherein said loading an operation code for each workflow module in the execution workflow framework, based on the execution workflow framework and the operation content includes: loading the operation code for each workflow module in the execution workflow framework based on the execution workflow framework and the operation content through a preset design pattern.

Clause A5. The method according to Clause A3 further including: semantically mapping the framework name of each workflow module with the name of each operation module in the operation content.

Clause A6. A method for generating an operation workflow, including: receiving at least one operation functional services sent by an operation development end; performing functional services combination based on operation requirements and the at least one operation functional services, to obtain an operation workflow; and saving the operation workflow that has passed the verification to obtain the target execution workflow.

Clause A7. The method according to Clause A6, wherein, after said saving the operation workflow that has passed the verification, the said method further includes: assigning a workflow number to the target execution workflow.

Clause A8. The method according to Clause A6, wherein said performing functional services combination based on operation requirements and the at least one operation functional services includes: selecting a required operation functional service, based on the operation requirements, from at least one operation functional services through a visualization view tool, to perform functional service combination.

Clause A9. The method according to Clause A6, wherein, after performing functional services combination based on operation requirements and the at least one operation functional services, to obtain an operation workflow, the method further includes: verifying the operation workflow.

Clause A10. A method for generating an operation workflow, including: acquiring a workflow configuration content; constructing each workflow module based on each node configuration content in the workflow configuration content; combining each workflow module, based on a workflow description in the workflow configuration content, to obtain an execution workflow framework; loading an operation code for each workflow module in the execution workflow framework, based on the execution workflow framework and the operation content, to obtain operation functional services; performing functional services combination, based on operation requirements and the at least one operation functional services, to obtain an operation workflow; and saving the operation workflow that has passed the verification to obtain the target execution workflow.

Clause A11. A method according to Clause A10, wherein said constructing each workflow module based on each node configuration content in the workflow configuration content includes: performing a legality check on the workflow configuration content to determine that the workflow structure corresponding to the workflow configuration content is a directed acyclic graph; and constructing each workflow module according to each node configuration content in the workflow structure, and performing a legality check on each workflow module.

Clause A12. A method according to Clause A10, wherein said loading an operation code for each workflow module in the execution workflow framework, based on the execution workflow framework and the operation content includes: loading the operation code for each workflow module in the execution workflow framework based on the execution workflow framework and the operation content through a preset design pattern.

Clause A13. The method according to Clause A10, further including: semantically mapping the framework name of each workflow module with the name of each operation module in the operation content.

Clause A14. The method according to Clause A10, wherein after said saving the operation workflow that has passed the verification, the method further includes: assigning a workflow number to the target execution workflow.

Clause A15. The method according to Clause A10, wherein said performing functional services combination based on operation requirements and the at least one operation functional services includes: selecting a required operation functional service, based on the operation requirements, from at least one operation functional services through a visualization view tool, to perform functional service combination.

Clause A16. The method according to Clause A10, wherein after performing functional services combination based on operation requirements and the at least one operation functional services, to obtain an operation workflow, the method further includes: verifying the operation workflow.

Clause A17. A device for generating an operation workflow, includes: memory; and at least one processor configured for:
acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end;
or
receiving an execution workflow framework sent by a platform development end; loading an operation code for each workflow module in the execution workflow framework, based on the execution workflow framework and the operation content, to obtain operation functional services; and sending the operation functional service to an operation manipulating end;
or
receiving at least one operation functional services sent by an operation development end; performing functional services combination based on operation requirements and the at least one operation functional services, to obtain an operation workflow; and saving the operation workflow that has passed the verification to obtain the target execution workflow;
or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.

Clause A18. A non-transitory machine-readable medium having stored thereon a program code for operation workflow generation, wherein when the program code is executed by at least one processor, the code guides the execution operation of the at least one processor, including:
acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end;
or
receiving an execution workflow framework sent by a platform development end; loading an operation code for each workflow module in the execution workflow framework, based on the execution workflow framework and the operation content, to obtain operation functional services; and sending the operation functional service to an operation manipulating end;
or
receiving at least one operation functional services sent by an operation development end; performing functional services combination based on operation requirements and the at least one operation functional services, to obtain an operation workflow; and saving the operation workflow that has passed the verification to obtain the target execution workflow;
or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.

Although multiple embodiments of the present application have been shown and described herein, it is obvious to the person of ordinary skill in the art that such embodiments are provided only by way of example. The person of ordinary skill in the art can think of many changes, modifications and alternatives without departing from the thought and spirit of the present application. It should be understood that in the process of practicing the present application, various alternatives to the embodiments of the present application described herein can be adopted. The attached claims are intended to limit the scope of protection of the present application, and therefore cover equivalents or alternatives within the scope of these claims.

What is claimed is:

1. A method for generating an operation workflow, the method comprising:
acquiring a workflow configuration content;
constructing each workflow module based on each node configuration content in the workflow configuration content;
combining each workflow module, based on a workflow description in the workflow configuration content, to obtain an execution workflow framework; and
sending the execution workflow framework to the operation development end.

2. The method according to claim 1, wherein said constructing each workflow module based on each node configuration content in the workflow configuration content comprises:
performing a legality check on the workflow configuration content to determine that the workflow structure corresponding to the workflow configuration content is a directed acyclic graph; and
constructing each workflow module according to each node configuration content in the workflow structure, and performing a legality check on each workflow module.

3. The method according to claim 1, further comprising:
loading an operation code for each workflow module in the execution workflow framework, based on the execution workflow framework and the operation content, to obtain operation functional services.

4. The method according to claim 3, wherein said loading an operation code for each workflow module in the execution workflow framework, based on the execution workflow framework and the operation content comprises:
loading the operation code for each workflow module in the execution workflow framework based on the execution workflow framework and the operation content through a preset design pattern.

5. The method according to claim 3, further comprising:
semantically mapping the framework name of each workflow module with the name of each operation module in the operation content.

6. The method according to claim 3, further comprising:
performing functional services combination based on operation requirements and the at least one operation functional services, to obtain an operation workflow; and
saving the operation workflow that has passed the verification to obtain the target execution workflow.

7. The method according to claim 6, wherein, after said saving the operation workflow that has passed the verification, the said method further comprises:
assigning a workflow number to the target execution workflow.

8. The method according to claim 6, wherein said performing functional services combination based on operation requirements and the at least one operation functional services comprises:
selecting a required operation functional service, based on the operation requirements, from at least one operation functional services through a visualization view tool, to perform functional service combination.

9. The method according to claim 6, wherein, after performing functional services combination based on operation requirements and the at least one operation functional services, to obtain an operation workflow, the method further comprises:
verifying the operation workflow.

10. A device for generating an operation workflow, comprising:
memory; and
at least one processor configured for:
acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end; or
receiving an execution workflow framework sent by a platform development end; loading an operation code for each workflow module in the execution workflow framework, based on the execution workflow framework and the operation content, to obtain operation functional services; and sending the operation functional service to an operation manipulating end; or
receiving at least one operation functional services sent by an operation development end; performing functional services combination based on operation requirements and the at least one operation functional services, to obtain an operation workflow; and saving the operation workflow that has passed the verification to obtain the target execution workflow; or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.

11. A non-transitory machine-readable medium having stored thereon a program code for operation workflow generation, wherein when the program code is executed by at least one processor, the code guides the execution operation of the at least one processor, comprising:
acquiring a workflow configuration content; constructing each workflow module based on each node configuration content in the workflow configuration content; combining each workflow module, based on a workflow description in the workflow configuration content, to obtain an execution workflow framework; and sending the execution workflow framework to the operation development end; or
receiving an execution workflow framework sent by a platform development end; loading an operation code for each workflow module in the execution workflow framework, based on the execution workflow framework and the operation content, to obtain operation functional services; and sending the operation functional service to an operation manipulating end; or
receiving at least one operation functional services sent by an operation development end; performing functional services combination based on operation requirements and the at least one operation functional services, to obtain an operation workflow; and saving the operation workflow that has passed the verification to obtain the target execution workflow; or
acquiring a workflow configuration content; constructing each workflow module based on each node configuration content in the workflow configuration content; combining each workflow module, based on a workflow description in the workflow configuration content, to obtain an execution workflow framework; and loading an operation code for each workflow module in the execution workflow framework, based on the execution workflow framework and the operation content, to obtain operation functional services; and performing functional services combination, based on operation requirements and the at least one operation functional services, to obtain an operation workflow; and saving the operation workflow that has passed the verification to obtain the target execution workflow.
